(19) United States
(12) Patent Application Publication
(10) Pub. No.: US 2021/0102627 A1
(43) Pub. Date: Apr. 8, 2021

(54) SEAL STRUCTURE

(71) Applicant: VALQUA, LTD., Tokyo (JP)

(72) Inventors: Takahiro YAMAMOTO, Machida-shi, Tokyo (JP); Chao JING, Tokyo (JP); Mitsuru MINAMI, Gojo-shi, Nara (JP); Akira UEDA, Gojo-shi, Nara (JP); Yuki NORIDUKI, Osaka-shi, Osaka (JP)

(21) Appl. No.: 16/607,981

(22) PCT Filed: May 11, 2017
(86) PCT No.: PCT/JP2017/017887

§ 371 Date: Oct. 24, 2019

(51) Int. Cl. F16J 15/18; F16J 15/16

(52) U.S. Cl. CPC F16J 15/18; E21B 10/25; F16J 15/164

(57) ABSTRACT

A seal member is disposed in a seal groove at a sliding gap between a shaft and a case. The seal member includes an outer periphery, a curved inner periphery, a mounting face, and an upper face. The mounting face is recessed toward the upper face. The upper face is recessed toward the mounting face. The relation of 0.755≤h/H≤0.769 is satisfied, where H [mm] denotes the longest length between the mounting face and the upper face and h [mm] denotes the shortest length between the mounting face and the upper face in the direction in which the center line of the seal member extends, in a cross section of the seal member taken along an imaginary plane in parallel with a direction orthogonal to a radial direction of the seal member and passing through the center line of the seal member,

### TECHNICAL FIELD

The present invention relates to a seal structure provided between a bit attachment shaft and a bit in an excavator.

### BACKGROUND ART

In excavators, techniques of prolonging the life of seal members for bits are disclosed in, for example, U.S. Patent Application Publication No. 2008/011518 (PTL 1), U.S. Patent Application Publication No. 2012/312602 (PTL 2), China Patent Application Publication No. 101629475 (PTL 3), China Patent Application Publication No. 102747961 (PTL 4), China Patent Application Publication No. 102747962 (PTL 5), and China Utility Model Publication No. 201786262 (PTL 6).

### CITATION LIST

### Patent Literature

PTL 1: U.S. Patent Application Publication No. 2008/011518

PTL 2: U.S. Patent Application Publication No. 2012/312602

PTL 3: China Patent Application Publication No. 101629475

PTL 4: China Patent Application Publication No. 102747961

PTL 5: China Patent Application Publication No. 102747962

PTL 6: China Utility Model Publication No. 201786262

### SUMMARY OF INVENTION

### Technical Problem

The seal structures disclosed in the above literatures improve the lubricating ability, the wear resistance and the like, thus prolonging the life of the seal members. However, there has been a demand for a longer life of seal members.

An object of the present invention is to provide a seal structure that can prolong the life of a seal member.

### Solution to Problem

A seal structure according to the present invention includes a ring-shaped seal member. The seal member is disposed in a seal groove provided in a case at a sliding gap between a shaft and the case. The seal member separates a high-pressure side from a low-pressure side. The seal groove provided in the case includes a low-pressure lateral face, a groove bottom, and a high-pressure lateral face. The low-pressure lateral face constitutes a lateral face of the seal groove on the low-pressure side. The low-pressure lateral face extends along a direction orthogonal to a shaft axial direction of the shaft in a cross section of the seal structure, the cross section being taken along an imaginary plane in parallel with the shaft axial direction and passing through a center line of the shaft. The groove bottom constitutes a bottom face of the seal groove. The groove bottom extends along the shaft axial direction in the cross section of the seal groove. The high-pressure lateral face constitutes a lateral face of the seal groove on the high-pressure side. The high-pressure lateral face extends along the direction orthogonal to the shaft axial direction in the cross section of the seal groove. The seal member includes an outer periphery facing the groove bottom, a curved inner periphery facing the shaft and protruding toward the shaft, a mounting face facing the low-pressure lateral face, and an upper face facing the high-pressure lateral face. The mounting face is recessed toward the upper face. The upper face is recessed toward the mounting face. The relation of 0.755≤h/H≤0.769 is satisfied, where H [min] denotes the longest length between the mounting face and the upper face in a direction in which a center line of the seal member extends, and h [min] denotes the shortest length between the mounting face and the upper face in the direction in which the center line of the seal member extends, in a cross section of the seal member taken along an imaginary plane in parallel with a direction orthogonal to a radial direction of the seal member and passing through the center line of the seal member.

The seal structure can reduce the sliding heat between the shaft and the seal member. This can prolong the life of the seal member.

in the seal structure, H-h, calculated with the H and the h, satisfies 0.9≤H-h ≤1.2. This can reduce the sliding heat between the shaft and the seal member.

In the seal structure, the H satisfies 3.9≤H≤4.9. This can reduce the sliding heat between the shaft and the seal member.

In the seal structure, 0.877≤W/W1≤0.880 is satisfied, where W1 [mm] denotes the longest length between the inner periphery and the outer periphery in the cross section of the seal member, and W [mm] denotes the length from the groove bottom to the shaft in the cross section of the seal structure. This can improve the sealability.

In the seal structure, W1-W, calculated with the W1 and the W, satisfies 0.75≤W1-W≤0.80. This can improve the sealability.

In the seal structure, in the cross section of the seal member, the seal member is symmetrical in shape with respect to a second center line extending along the radial direction. This can improve the productivity. ADVANTAGEOUS EFFECTS OF INVENTION

The present invention provides a seal structure that can prolong the life of a seal member.

### BRIEF DESCRIPTION OF DRAWINGS

FIG. 1 is a cross-sectional view showing a bit and a bit attachment shaft in an excavator.

FIG. 2 is a plan view of a seal member to be disposed in a seal groove according to an embodiment.

FIG. 3 is a side view of the seal member shown in FIG. 2.

FIG. 4 is a cross-sectional view of the seal member taken along line A-A shown in FIG. 2.

FIG. 5 is a schematic view showing a cross section of a seal structure,

FIG. 6 is a schematic view showing a state in which a pressure is applied from the high-pressure side to a seal member.

FIG. 7 is a schematic view showing the dimensions of a seal groove and a shall according to an embodiment.

FIG. 8 is a schematic view showing the dimensions of a seal member according to an embodiment.

FIG. 9 is a table showing the evaluation results for various seal members.

### DESCRIPTION OF EMBODIMENTS

Hereinafter a seal structure in an embodiment is described with reference to the drawings. In the embodiment described below, identical or substantially identical components are denoted by identical reference signs, and redundant description is not repeated.

(Bit 2)

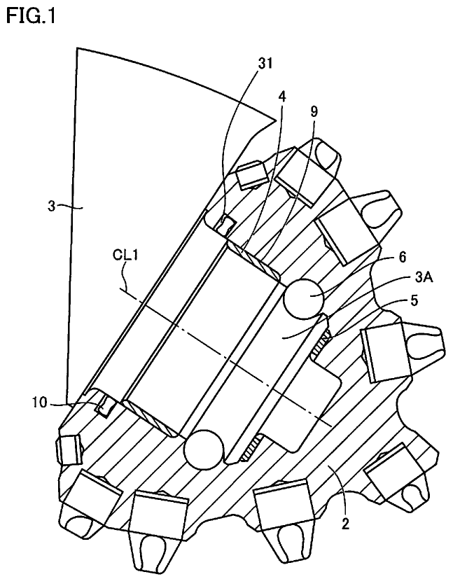

With reference to FIG. 1, a hit 2 and a bit attachment shaft 3A at an end of an excavator are described, where a seal structure 1 in the present embodiment is employed. FIG. 1 is a cross-sectional view showing bit 2 and bit attachment shaft 3A in the excavator. Bit 2 is attached to bit attachment shaft 3A on a bit attachment base 3 in such a way that bit 2 is rotatable at high speed. Bit 2 has a cylindrical insertion hole 9, Insertion hole 9 has a spherical bearing 6. Bit attachment shaft 3A is inserted in spherical bearing 6. Between insertion hole 9 and bit attachment shaft 3A, lubricating oil 4, 5 is held.

A seal groove 31 for a seal member 10 to be fitted therein is provided in a region of bit attachment shaft 3A near its base. Seal groove 31 has a ring shape at the inner periphery of insertion hole 9 in bit 2.

Bit 2 employs a so-called down-hole motor (mud motor) mechanism in which bit 2 rotates around the rotation center axis CLI with the force of muddy water as motive power.

For example, if bit attachment shaft 3A has a diameter of about φ 55 min, the rotation region of bit 2 can be divided into a low-speed rotation region (100 to 200 rpm), a medium-speed rotation region (200 to 500 rpm), and a high-speed rotation region (500 rpm or more). The present embodiment assumes a configuration for a medium-speed rotation region (200 to 500 rpm).

(Seal Structure 1)

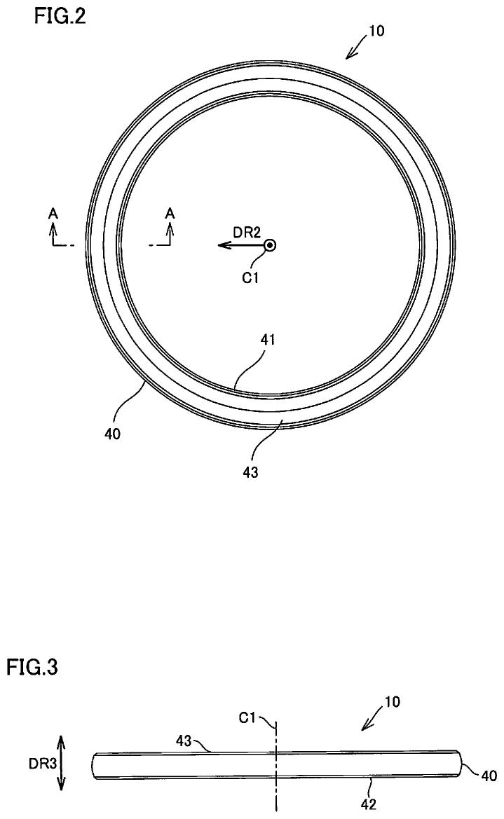

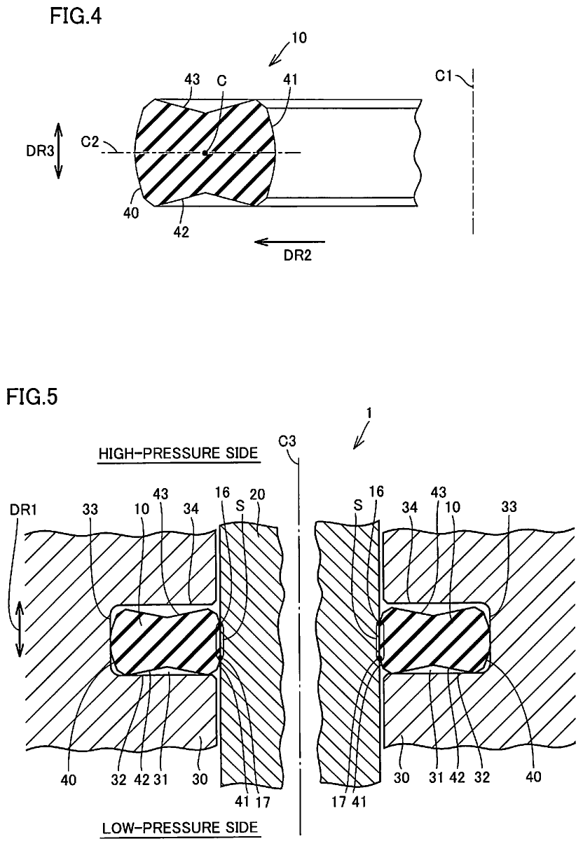

FIG. 2 is a plan view of seal member 10 to be disposed in seal groove 31 according to an embodiment. FIG. 3 is a side view of seal member 10 shown in FIG. 2. FIG. 4 is a cross-sectional view of seal member 10 taken along line A-A shown in FIG. 2. With reference to FIG. 2 to FIG. 4, seal member 10 is described.

Seal member 10 has a ring shape. Seal member 10 has a prescribed thickness in a thickness direction DR3, The cross-sectional view of FIG. 4 along line A-A is a cross-sectional view taken along an imaginary plane in parallel with a direction (thickness direction DR3) orthogonal to a radial direction DR2 of seal member 10 and passing through center line Cl of seal member 10.

The cross section of seal member 10 taken along line A-A is symmetrical in shape with respect to second center line C2 extending along radial direction DR2. Seal member 10 having a symmetrical shape with respect to second center line C2 can eliminate the risk that seal member 10 might be assembled to seal groove 31 in a wrong orientation. This can improve the productivity, thus reducing the manufacturing cost.

Seal member 10 includes an outer periphery 40, an inner periphery 41, a mounting face 42, and an upper face 43. Outer periphery 40 constitutes the outer periphery of ring-shaped seal member 10. Outer periphery 40 is opposite to inner periphery 41. Outer periphery 40 protrudes in the direction away from inner periphery 41. Outer periphery 40 is curved. The cross section of outer periphery 40 taken along line A-A shown in FIG. 4 is in the shape of a circular arc.

Inner periphery 41 constitutes the inner periphery of ring-shaped seal member 10. Inner periphery 41 protrudes in the direction away from outer periphery 40, Inner periphery 41 is curved. The cross section of inner periphery 41 taken along line A-A shown in FIG. 4 is in the shape of a circular arc.

Mounting face 42 and upper face 43 are opposite to each other. Mounting face 42 is recessed toward upper face 43. Upper face 43 is recessed toward mounting face 42. The recessed mounting face 42 and upper face 43 define the thickness of seal member 10 in thickness direction DR3 such that, in radial direction DR2 shown in FIG. 4, the thickness becomes smaller toward center C in the cross section of seal member 10 taken along line A-A.

Seal member 10 is composed of, for example, hydrogenated nitrile butadiene rubber (HNBR). Instead of HNBR, seal member 10 may be composed of an elastomer material with a nanomaterial added thereto to enhance the properties of the elastomer itself. Seal member 10 has a Shore-A hardness of, for example, 90.

Seal member 10 in an embodiment is disposed in seal groove 31 formed in a case 30, at a sliding gap between shaft 20 and case 30 described later.

FIG. 5 is a schematic view showing a cross section of seal structure 1. The cross section shown in FIG. 5 is a cross section of seal structure 1 taken along an imaginary plane in parallel with shaft axial direction DRI and passing through center line C3 of shaft 20. In an embodiment, shaft 20 is bit attachment shaft 3A. In an embodiment, case 30 is bit 2. Shaft axial direction URI is the direction in which shaft 20 extends, i.e., the vertical direction on the FIG. 5 sheet.

In the sliding gap between shaft 20 and case 30, the upper side relative to seal groove 31 is a high-pressure side from which muddy water, sand and the like come, and the lower side relative to seal groove 31 is a low-pressure side where spherical bearing 6 is disposed. Seal member 10 separates the high-pressure side from the low-pressure side. Seal member 10 blocks muddy water, sand and the like from entering from the high-pressure side, and minimizes damage to spherical bearing 6.

Seal groove 31 provided in case 30 has a low-pressure lateral face 32, a high-pressure lateral face 34, and a groove bottom 33. Low-pressure lateral face 32 constitutes the lateral face of seal groove 31 on the low-pressure side. In the above-described cross section of seal structure 1, low-pressure lateral face 32 extends along a direction orthogonal to shaft axial direction DRI. High-pressure lateral face 34 constitutes the lateral face of seal groove 31 on the high-pressure side. In the above-described cross section of seal structure 1, high-pressure lateral face 34 extends along a direction orthogonal to shaft axial direction DR1.

Groove bottom 33 constitutes the bottom face of seal groove 31. Groove bottom 33 extends along shaft axial direction DRI. Groove bottom 33 is connected to high-pressure lateral face 34 at one end of groove bottom 33. Groove bottom 33 is connected to low-pressure lateral face 32 at the other end of groove bottom 33.

Seal member 10 is disposed to be surrounded by shaft 20 and seal groove 31. With seal member 10 disposed in seal groove 31, mounting face 42 faces low-pressure lateral face 32, and upper face 43 faces high-pressure lateral face 34.

Outer periphery 40 faces groove bottom 33. Outer periphery 40 is pressed by groove bottom 33. Inner periphery 41 faces shaft 20. Inner periphery 41 is pressed by shaft 20. Inner periphery 41 includes a contact region S in contact with shaft 20. Contact region S is formed with inner periphery 41 being pressed by shaft 20.

Contact region S includes an upper-end contact portion 16 that is closest to the high-pressure side in contact region S in shaft axial direction DR1. Contact region S includes a lower-end contact portion 17 that is closest to the low-pressure side in contact region S in shaft axial direction DR1.

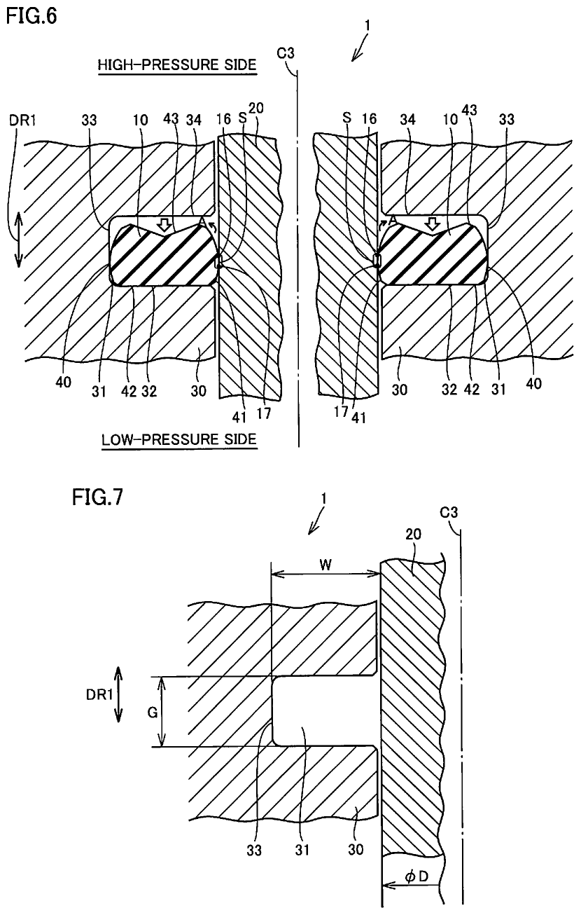

FIG. 6 is a schematic view showing a state in which a pressure is applied from the high-pressure side to seal member 10. A pressure applied to upper face 43 (indicated by the hollow arrows in FIG. 6) deforms the whole seal member 10 so that the recessed part of mounting face 42 comes in contact with low-pressure lateral face 32.

Accordingly, bending deformation of inner periphery 4loccurs as indicated by arrows A in FIG. 6. The deformation of inner periphery 41 reduces the size of contact region S as compared to FIG. 5 that shows a state before the application of pressure. The size reduction of contact region S reduces the contact area between shaft 20 and seal member 10, thus reducing the sliding heat between shaft 20 and seal member 10. This can prolong the life of seal member 10.

Further, when the bending deformation of inner periphery 41 occurs as indicated by arrows A in FIG. 6, a part of inner periphery 41 around upper-end contact portion 16 tends to go away from shaft 20, thus reducing the contact pressure around upper-end contact portion 16. This causes muddy water to enter around upper-end contact portion 16 from the high-pressure side.

On the other hand, when the bending deformation of inner periphery 41 occurs, a part of inner periphery 41 around lower-end contact portion 17 is pressed by shaft 20, thus increasing the contact pressure between shaft 20 and seal member 10 around lower-end contact portion 17. At a location at a certain distance or longer from upper-end contact portion 16 in the downward direction on the FIG. 6 sheet, the entry of muddy water is minimized.

By allowing muddy water to come to a certain position in contact region S, the slidability between seal member 10 and shaft 20 can be improved. Further, since muddy water cools seal member 10, the sliding heat between shaft 20 and seal member 10 can be reduced. This can prolong the life of seal member 10.

### EXAMPLES

By conducting studies, the inventors have found that the relationship between the dimensions of seal member 10 and the dimensions of seal groove 31 greatly affects the life of seal member 10.

FIG. 7 is a schematic view showing the dimensions of seal groove 31 and shaft 20 according to an embodiment. The cross section shown in FIG. 7 is a cross section of seal structure 1 taken along an imaginary plane in parallel with shaft axial direction DR1 and passing through center line C3 of shaft 20. The length from groove bottom 33 to shaft 20 is denoted by W [mm], the length of groove bottom 33 in shaft axial direction DR1 is denoted by G [mm], and the diameter of shaft 20 is denoted by [mm].

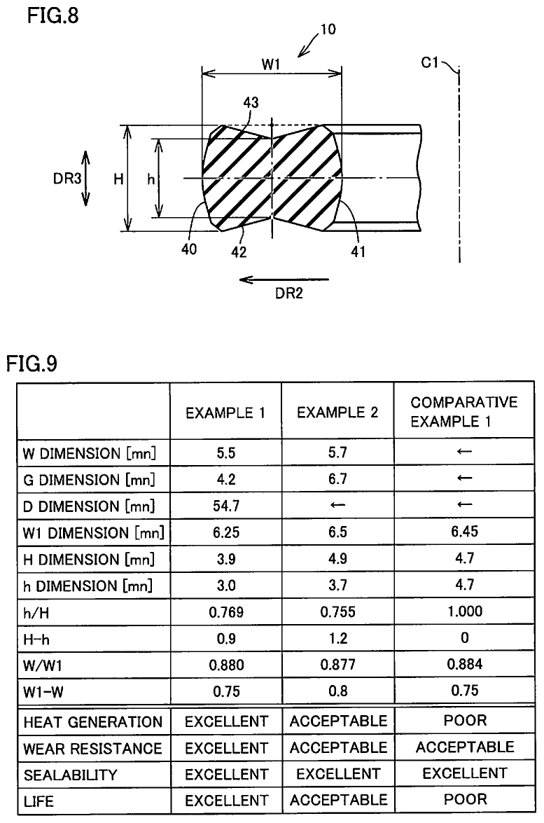

FIG. 8 is a schematic view showing the dimensions of seal member 10 according to an embodiment. The cross section shown in FIG. 8 is a cross section of seal member 10 taken along an imaginary plane in parallel with a direction (thickness direction DR3) orthogonal to radial direction DR2 of seal member 10 and passing through center line C1 of seal member 10. In the direction in which center line C1 of seal member 10 extends (thickness direction DR3), the longest length between mounting face 42 and upper face 43 is denoted by H [mm], and the shortest length between mounting face 42 and upper face 43 is denoted by h [mm]. The longest length between inner periphery 41 and outer periphery 40 is denoted by W1 [mm].

With seal member 10 according to an embodiment, evaluation was made for the heat generation, the wear resistance, the seal/ability, and the seal life of seal member 10, with respect to various seal members 10 having different dimensions (examples 1 and 2 and comparative example 1 described below). The excellent level is denoted by “excellent”, the acceptable level is denoted by “acceptable”, and the poor level is denoted by “poor”.

FIG. 9 is a table showing the evaluation results for various seal members 10. With respect to the sealability, all of example 1, example 2, and comparative example 1 present the excellent level. The sealability relates to the size of contact region S. A larger contact region S provides a larger contact area between shaft 20 and inner periphery 41 and thus provides better sealability.

The size of contact region S relates to dimension H of seal member 10. A larger dimension H provides a larger contact region S and thus provides better sealability. The fact that all of example 1, example 2, and comparative example 1 present the excellent level of sealability shows that they all have sufficient dimensions H which relate to their contact region S sizes.

Focusing on h/H obtained by dividing h by H, in the case of h/H=1 (comparative example 1), no recess is formed in the upper face and the mounting face, and the seal member has no thickness-reduced portion. Accordingly, a pressure applied to the upper face would not cause the inner periphery of the seal member to deform as indicated by arrows A in FIG. 6.

Since the inner periphery of the seal member does not deform, the contact region is not recued in size. Due to no size reduction of the contact region, the sliding heat between the shaft and the seal member cannot be reduced. Therefore, the heat generation is evaluated as “poor”. As a result, the life is evaluated as “poor”.

It can be seen from example 1 and example 2 that h/H within the range of 0.755≤h/H≤0.769 can prolong the life of seal member 10 while ensuring the sealability of seal member 10.

It can also be seen that H-h, calculated with H and h, within the range of 0.9≤H-h≤1.2 can prolong the life of seal member 10 while ensuring the sealability of seal member 10.

When example 1 is compared with example 2, example 1 is better than example 2 in the evaluation results of heat generation, wear resistance, and life. A larger contact region S causes greater sliding heat between shaft 20 and seal member 10, leading to lower wear resistance and shorter life.

H is smaller in example 1 than in example 2, which means that contact region S is smaller in example 1 smaller contact region S provides a smaller contact area between shaft 20 and inner periphery 41. Accordingly, seal member 10 in example 1 presents excellent evaluation results in heat generation and wear resistance. Thus, seal member 10 in example 1 is evaluated as better in seal life.

Example 1 and example 2 show that H within the range of 3.90≤H≤4,90 can prolong the life of seal member 10 while ensuring the sealability of seal member 10.

When seal member 10 is disposed in seal groove 31, inner periphery 41 is pressed by shaft 20, and outer periphery 40 is pressed by groove bottom 33. Thus, seal member 10 is compressed in seal groove 31.

W/W1 shown in FIG. 9 is a parameter that indicates the degree to which seal member 10 is compressed by seal groove 31 and shaft 20. The more seat member 10 is compressed, the larger the contact pressure between shaft 20 and seal member 10 is. A larger contact pressure provides better sealability but causes greater sliding heat and leads to a shorter life.

It can be seen from FIG. 9 that W/W1 within the range of 0.877≤WW1≤0.880 can prolong the life of seal member 10 while ensuring the sealability of seal member 10.

It can also be seen that W1-W, calculated with W1 and W, within the range of 0.75≤W1-W≤0.80 can prolong the life of seal member 10 while ensuring the sealability of seal member 10.

By appropriately setting the dimensions of seal member 10 and the dimensions of seal groove 31, provided is seal structure 1 that can prolong the life of seal member 10 while ensuring the sealability.

Although seal member 10 is symmetrical in shape with respect to second center line C2 in the embodiment, the symmetry is not mandatory. Each of the recesses in mounting face 42 and upper face 43 may he a recess in the shape of, for example, a circular arc.

It should be understood that the embodiment and examples disclosed herein are by way of example in every respect, not by way of limitation. The scope of the present invention is defined not by the above description but by the terms of the claims, and is intended to include any modification within the meaning and scope equivalent to the terms of the claims.

### REFERENCE SIGNS LIST

1: seal structure; 10: seal member; 16: upper-end contact portion; 17: lower-end contact portion; 20: shaft; 30: case; 31: seal groove; 32: low-pressure lateral face; 33: groove bottom; 34: high-pressure lateral face; 40: outer periphery; 41: inner periphery; 42: mounting face; 43: upper face; DR1:shaft axial direction; DR2: radial direction; DR3: thickness direction; C: center; C1, C3: center line; C2: second center line

1. A seal structure comprising a ring-shaped seal member disposed in a seal groove provided in a case at a sliding gap between a shaft and the case, the seal member separating a high-pressure side from a low-pressure side,
the seal groove provided in the case including
a low-pressure lateral face constituting a lateral face of the seal groove on the low-pressure side, and extending along a direction orthogonal to a shaft axial direction of the shaft in a cross section of the seal structure, the cross section being taken along an imaginary plane in parallel with the shaft axial direction and passing through a center line of the shaft,
a groove bottom constituting a bottom face of the seal groove, and extending along the shaft axial direction in the cross section, and
a high-pressure lateral face constituting a lateral face of the seal groove on the high-pressure side, and extending along the direction orthogonal to the shaft axial direction in the cross section,
the seal member including
an outer periphery facing the groove bottom,
a curved inner periphery facing the shaft and protruding toward the shaft,
a mounting face facing the low-pressure lateral face, and
an upper face facing the high-pressure lateral face, the mounting face being recessed toward the upper face, the upper face being recessed toward the mounting face,
0.755≤h/H≤0.769 being satisfied, where H [mm] denotes a longest length between the mounting face and the upper face in a direction in which a center line of the seal member extends, and h [mm] denotes a shortest length between the mounting face and the upper face in the direction in which the center line of the seal member extends, in a cross section of the seal member taken along an imaginary plane in parallel with a direction orthogonal to a radial direction of the seal member and passing through the center line of the seal member.

2. The seal structure according to claim 1, wherein H-h, calculated with the H and the h, satisfies 0.9≤H-h≤1.2.

3. The seal structure according to claim 1, wherein the H satisfies 3.9≤H≤4.9.

4. The seal structure according to claim 1, wherein 0.877≤W/W1≤0.880 is satisfied, where W1 [m/m] denotes a longest length between the inner periphery and the outer periphery in the cross section of the seal member, and W [mm] denotes a length from the groove bottom to the shaft in the cross section of the seal structure.

5. The seal structure according to claim 4, wherein W1-W, calculated with the W1 and the W, satisfies 0.75≤W1-W≤0.80.

6. The seal structure according to claim 1, wherein, in the cross section of the seal member, the seal member is symmetrical in shape with respect to a second center line extending along the radial direction.
